(19) United States
(12) Patent Application Publication
(10) Pub. No.: US 2017/0055755 A1
(43) Pub. Date: Mar. 2, 2017

(54) METHOD, DEVICE AND ELECTRONIC DEVICE FOR HEATING AN INNER COOKING PAN OF AN INDUCTION COOKING EQUIPMENT AND COMPUTER-READABLE MEDIUM

(71) Applicant: Xiaomi Inc., Beijing (CN)

(72) Inventors: Ke WU, Beijing (CN); Xinyu Liu, Beijing (CN)

(73) Assignee: Xiaomi Inc., Beijing (CN)

(21) Appl. No.: 15/135,149

(22) Filed: Apr. 21, 2016

(30) Foreign Application Priority Data
Aug. 31, 2015 (CN) 201510549421.4

(51) Int. Cl. A47J 27/00; H05B 6/06; G06K 7/14; A47J 36/00; G06K 7/10

(52) U.S. Cl. CPC A47J 27/004; A23L 1/0128; A47J 36/00; G06K 7/10366; G06K 7/1413; H05B 6/062; A23V 2002/00

(57) ABSTRACT

The present disclosure relates to a method, device and electronic device for heating an inner cooking pan of an induction cooking equipment and computer-readable medium. The method can comprise: determining a material type of an inner cooking pan; and selecting a voltage change curve matching with the material type for use in a cooking process of the induction cooking equipment where the inner cooking pan is installed. In the technical solutions of the disclosure, different material types of inner cooking pans can obtain same or similar heating result by selecting a voltage change curve matching with a material type of an inner cooking pan.

### CROSS-REFERENCE TO RELATED APPLICATION

This application bases on and claims priority to Chinese Patent Application No. 201510549421.4, filed Aug. 31, 2015, which is incorporated herein by reference in its entirety.

### FIELD

The present disclosure generally relates to the field of home furnishing electronic technology, and more particularly to method, device and electronic device for heating an inner cooking pan of an induction cooking equipment and computer-readable medium.

### BACKGROUND

A cooking equipment can heat the food by converting electric energy to heat energy so as to achieve the goal of cooking. In a cooking equipment, performing electric-to-heat conversion by adopting “a heating plate” refers to transferring the heat to an inner cooking pan in which the food are placed in a cooking equipment by the heating plate after heating the heating plate by electric energy, then heating the food by the inner cooking pan.

However, although a heating plate has a simple structure and is easy to be controlled, the problems of uneven heating, poor temperature control accuracy and the like exist.

### SUMMARY

Method, device and electronic device for heating an inner cooking pan of an induction cooking equipment and computer-readable medium are provided in the disclosure, so as to address the deficiency in related arts.

Aspects of the disclosure provide a method for heating an inner cooking pan of an induction cooking equipment. The method includes determining a material type of the inner cooking pan and selecting a voltage change curve based on the material type for use in a cooking process of the induction cooking equipment where the inner cooking pan is installed.

To determine the material type of the inner cooking pan, in an example, the method includes acquiring the material type that is encoded in a barcode graph on a surface of the inner cooking pan. To acquire the material type that is encoded in the barcode graph on the surface of the inner cooking pan, in an example, the method includes acquiring and decoding the barcode graph to acquire the material type encoded in the barcode graph. In another example, the method includes receiving an assisting message with the material type sent by a mobile device. The mobile device is configured to read the barcode graph and decode the barcode graph to acquire the material type.

Further, in an embodiment, to determine the material type of the inner cooking pan, the method includes receiving a notification message sent by an electronic label on the inner cooking pan, the notification message comprising the material type of the inner cooking pan.

According to an aspect of the disclosure, a surface of the inner cooking pan includes a physical structure corresponding to the material type. Thus, to determine the material type of the inner cooking pan, the method includes detecting the physical structure of the surface of the inner cooking pan using a detection structure of the induction cooking equipment after the inner cooking pan is installed into the induction cooking equipment so as to determine the material type of the inner cooking pan. For example, the physical structure is a convex structure on a bottom of the inner cooking pan, a location of the convex structure on the bottom of the inner cooking pan is indicative of the material type. The detection structure includes a plurality of concave structures on an inside bottom of the induction cooking equipment, and the plurality of concave structures correspond to a plurality of material types respectively. Then, to detect the physical structure of the surface of the inner cooking pan using the detection structure in the induction cooking equipment, the method includes determining a corresponding material type according to a concave structure in the detection structure that matches with the convex structure on the bottom of the inner cooking pan after the inner cooking pan is installed into the induction cooking equipment.

According to an aspect of the disclosure, the method further includes receiving configuration instructions, and generating the voltage change curve according to the configuration instructions and the material type. According to another aspect of the disclosure, the method includes downloading the voltage change curve from a server.

Aspects of the disclosure provide a device for heating an inner cooking pan of an induction cooking equipment. The method includes a processor and a memory for storing processor-executable instructions. The processor is configured to determine a material type of the inner cooking pan and select a voltage change curve based on the material type for use in a cooking process of the induction cooking equipment where the inner cooking pan is installed.

Aspects of the disclosure provide a non-transitory computer-readable storage medium having stored therein instructions that, when executed by a processor of a mobile terminal device, causes the mobile terminal device to perform a method for heating an inner cooking pan of an induction cooking equipment. The method includes determining a material type of an inner cooking pan and selecting a voltage change curve based on the material type for use in a cooking process of the induction cooking equipment where the inner cooking pan is installed.

It is to be understood that both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram of heating an inner cooking pan of an ordinary cooking equipment in related arts.

FIG. 2 is a schematic diagram of heating an inner cooking pan of an induction cooking equipment in related arts.

FIG. 3 is a schematic diagram of a cooking curve in related arts.

FIG. 4 is a schematic diagram of a voltage change curve in related arts.

FIG. 5 is a flow chart illustrating a method for heating an inner cooking pan of an induction cooking equipment according to an exemplary embodiment.

FIG. 6 is a schematic diagram illustrating a method for identifying a material type of an inner cooking pan according to an exemplary embodiment.

FIG. 7 is a schematic diagram illustrating another method for identifying a material type of an inner cooking pan according to an exemplary embodiment.

FIG. 8 is a schematic diagram illustrating still another method for identifying a material type of an inner cooking pan according to an exemplary embodiment.

FIG. 9 is a schematic diagram illustrating still another method for identifying a material type of an inner cooking pan according to an exemplary embodiment.

FIGS. 10-15 is a block diagram illustrating a device for heating an inner cooking pan of an induction cooking equipment according to an exemplary embodiment.

FIG. 16 is a structural schematic diagram illustrating a device for heating an inner cooking pan of an induction cooking equipment according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of device and methods consistent with aspects related to the invention as recited in the appended claims.

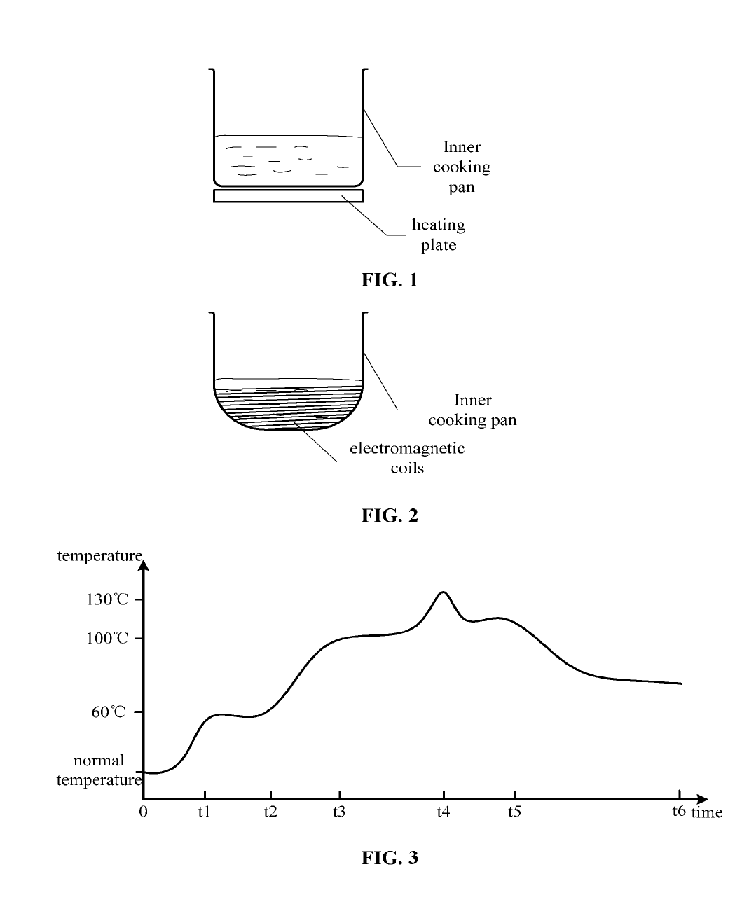

FIG. 1 is a schematic diagram of heating an inner cooking pan of an ordinary cooking equipment in related arts. As shown in FIG. 1, in an ordinary cooking equipment, the function of heating an inner cooking pan is achieved by adopting a heating plate. Specially, a heating plate may be equivalent to a resistor, and a heating plate can be heated when electric energy is outputted to the heating plate. Then the heating plate can transfer heat to an inner cooking pan, and finally the inner cooking pan can transfer heat to the food within the inner cooking pan so as to achieve the heating and cooking of the food.

As mentioned in background, an ordinary cooking equipment using a heating plate may cause the problems of uneven heating, poor temperature control accuracy and the like, this may affect cooking effect.

In view of the fact in related arts, an induction cooking equipment using Induction Heating (IH) is further provided in related arts. As shown in FIG. 2, high frequency alternating current may be transferred to electromagnetic coils according to predefined voltage change curve, so that the electromagnetic coils may cause high frequency alternative magnetic field. The high frequency alternative magnetic field may drive microcrystalline structure in magnetic metal material in an inner cooking pan to generate vortex, so as to heat the food directly with heat through fiction among vortex generated by numerous microcrystalline structures.

Users always want to achieve the same cooking effect when cooking the same food. For example, FIG. 3 shows a cooking curve actually required for the food as “rice” in the process of “cooking rice”, the cooking curve may include: a pre-heating phase under normal temperature during the time period from 0 to t1; a water absorption phase under middle temperature of 60° C. during the time period from t1 to t2; a heating phase under big fire that the temperature is heated to 100° C. during the time period from t2 to t3; a boiling phase that the temperature is heated to 130° C. during the time period from t3 to t4; a braising phase under high temperature during the time period from t4 to t5; a heat preservation phase during the time period from t5 to t6. As such, the same cooking effect can be achieved if an induction cooking equipment can make the heat received by the “rice” in the cooking process of “cooking rice” conform to the cooking curve shown in FIG. 3. In other words, the same cooking effect can be achieved even if different inner cooking pans are used if it's ensured that the heating power of an inner cooking pan in an induction cooking equipment always conform to the heat required for a cooking curve corresponding to current food and current cooking method.

Based on the equation for calculating power P=U/I=U²/R (P is power, U is voltage, I is current, R is resistance), it can be known that: in the case of the same U, if it's needed to produce the same heating power P, then it's needed to ensure that the resistances R of the inner cooking pans are the same. However, the resistivity p of the inner cooking pans always are different when the inner cooking pans using different material types. As the value of the resistance R is proportional to that of the resistivity p, if the resistivity p of the material type of an inner cooking pan is larger, then the corresponding resistance R is larger. As such, in the case of the same U, the power will be smaller, thus it may not be ensured that the heating power of an inner cooking pan always conform to the requirement of the cooking curve shown in FIG. 3.

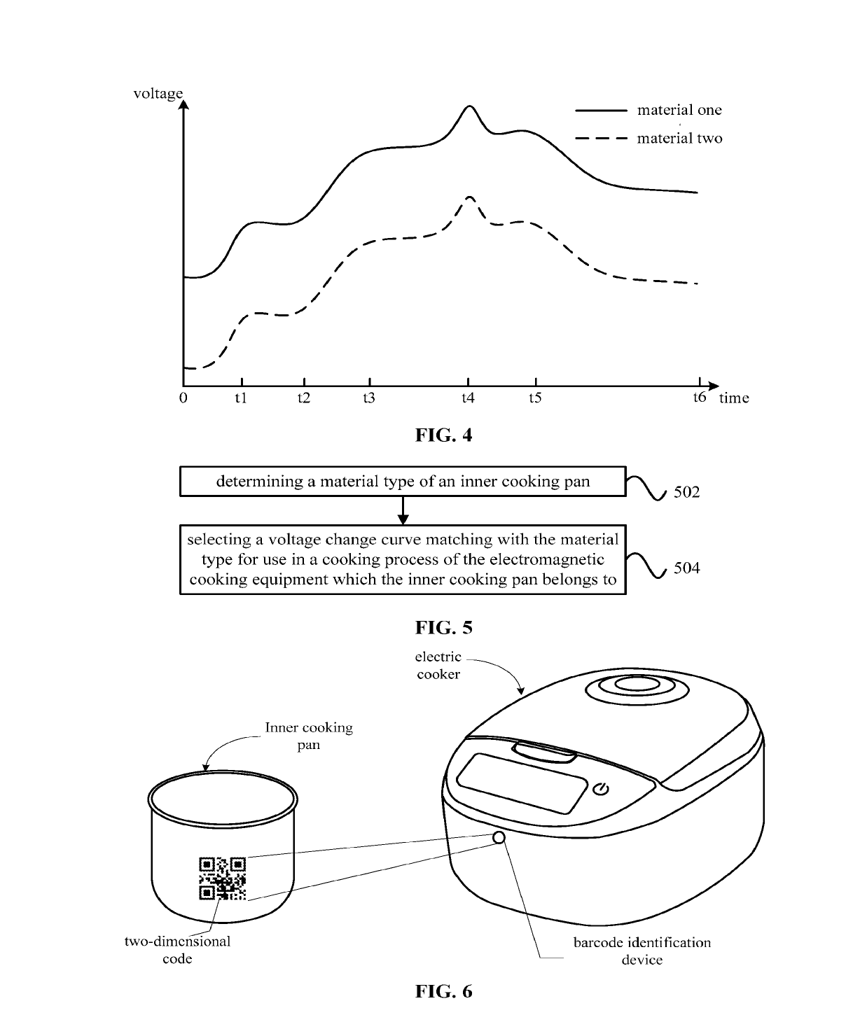

As such, in the case of the material types of the inner cooking pans are different, the value of the real voltage U should be determined according to the material type of an inner cooking pan and the corresponding resistivity p, so as to different material types of inner cooking pans can generate the same heating power P. For example, in FIG. 4, when two kinds of inner cooking pans are made by using material one and material two respectively, it's assumed that the resistivity p of material one is greater than the resistivity p of material two, then a larger voltage U1 is needed to be applied to the inner cooking pan consist of material one and a smaller voltage U2 is needed to be applied to the inner cooking pan consist of material two, so that the two inner cooking pans can obtain the same heating power P at the same time point. In other words, for the inner cooking pans using different material types, different voltage change curves should be used when performing the same cooking operation on the same food, so as to ensure that the same cooking effect may be achieved.

However, the induction cooking equipment in related arts only takes into account the change of the food or cooking method, and does not take into account the support of different material types of inner cooking pans in a same induction cooking equipment, leading to that different material types of inner cooking pans always use same voltage change curve when performing the same cooking operation on the same food, thus leading to that the heat received by the food are different and may not always conform to the requirement of the heating curve shown in FIG. 3.

Therefore, the present disclosure improves the heating process of an induction cooking equipment, so as to address above technical problems in related arts.

FIG. 5 is a flow chart illustrating a method for heating an inner cooking pan of an induction cooking equipment according to an exemplary embodiment. As shown in FIG. 5, the method is used in an induction cooking equipment, and may include the following steps:

In step 502, determining a material type of an inner cooking pan.

In step 504, selecting a voltage change curve matching with the material type for use in a cooking process of the induction cooking equipment which the inner cooking pan belongs to.

In the above embodiments, by determining a material type of an inner cooking pan, different material types of inner cooking pans can obtain the same or similar heating result by selecting a voltage change curve matching with a material type of an inner cooking pan, and an induction cooking equipment can be compatible with different material types of inner cooking pans

In the technical solutions of the present disclosure, a material type of an inner cooking pan may be identified by various methods. Several possible implementations thereof will be described in detail in the following. Of course, other methods capable of identifying a material type of an inner cooking pan may be used in the embodiments of the present disclosure, and the present disclosure is not limited to the following methods.

### Embodiment 1

### Barcode Identification

As an exemplary embodiment, the material type of an inner cooking pan contained in a barcode graph on a surface of the inner cooking pan can be acquired.

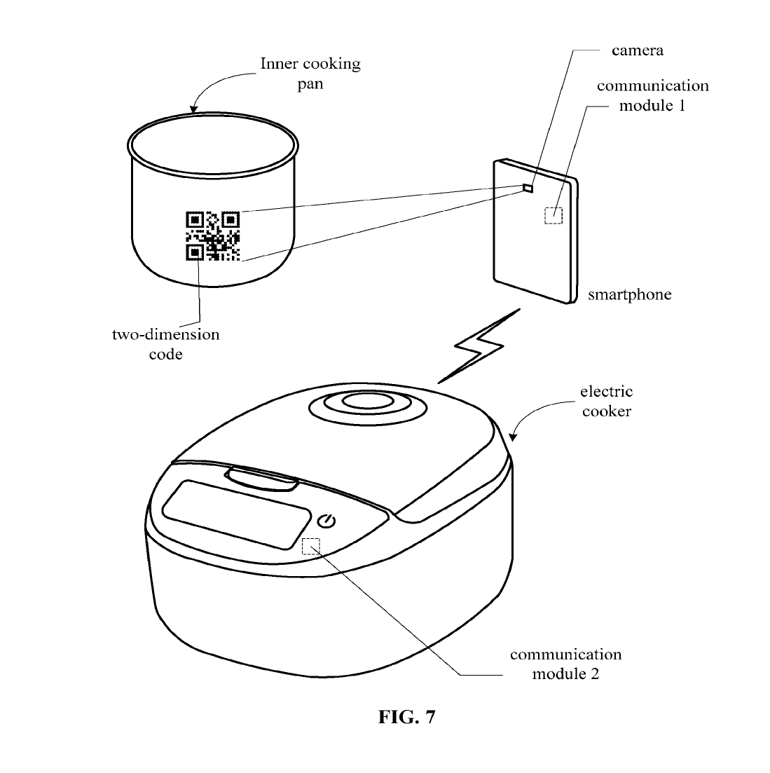

In the present embodiment, a barcode graph (for example, two-dimension code shown in FIGS. 6-7) is generated on an external surface of the inner cooking pan (or any other positions such as a surface of a packing box of the inner cooking pan) during the process of producing an inner cooking pan by a manufacturer. The barcode graph contains the material type of the inner cooking pan. As such, the material type of the inner cooking pan can be read by collecting and identifying the barcode graph.

Correspondingly, based on the cooking methods (each having a corresponding cooking curve) supported by an induction cooking equipment, each method may have a corresponding voltage change curve for various material types, so as to ensure that these material types of inner cooking pans can achieve same or similar cooking effect in the case of same cooking method. Therefore, after a material type of current tank is determined according to a barcode graph, a voltage change curve corresponding to the material type can be selected correctly, so that the heating power generated by the inner cooking pan can conform to the heat required for the corresponding cooking curve.

1. Direct Identification

In an exemplary embodiment, an induction cooking equipment can acquire and analyze a barcode graph on an inner cooking pan directly, so as to acquire the material type of the inner cooking pan contained in the barcode graph.

For example, an induction cooking equipment may be “an electric cooker”, and a barcode graph on an inner cooking pan may be “two-dimensional code”. As shown in FIG. 6, a barcode graph is printed or pasted on a surface of an inner cooking pan, and the electric cooker may be configured with a barcode identification device such as a camera. The barcode identification device can collect the graph of a barcode graph and identify the material type contained in the graph by making the barcode graph towards to the barcode identification device.

For example, it's assumed that a material type of “100012” is acquired after identifying the barcode graph by the barcode identification device, for example, when the material type corresponding to “100012” is “material one”, then a voltage change curve corresponding to material one in FIG. 4 should be used when the electric cooker selects the inner cooking pan to perform a cooking operation of “cooking rice” on the “rice”.

2. Assisting Identification

In another exemplary embodiment, an induction cooking equipment can receive an assisting message sent by a mobile device, the assisting message comprising the material type of the inner cooking pan; wherein, the material type is acquired by acquiring and analyzing the barcode graph on the inner cooking pan by the mobile device.

For example, an induction cooking equipment may be “an electric cooker”, a mobile device may be a smart phone, and a barcode graph on an inner cooking pan may be “two-dimensional code”. As shown in FIG. 7, a barcode graph is printed or pasted on a surface of an inner cooking pan. The smart phone can collect the graph of a barcode graph and identify the material type contained in the graph by a camera. Accordingly, the electric cooker may not have to be configured with a barcode identification device such as a camera.

For example, it's assumed that a material type contained in two-dimensional code on an inner cooking pan read by a smart phone is“100012”, then the smart phone needs to send the material type to the electric cooker. So the smart phone and the electric cooker should be configured with a communication module 1 and a communication module 2 respectively. The smart phone can send the type material “100012” to the electric cooker through the communication connection between the communication module 1 and the communication module 2. Then the electric cooker can know the material type of the inner cooking pan and select a corresponding voltage change curve.

### Embodiment 2

### Label Reading

As another exemplary embodiment, an induction cooking equipment can receive a notification message sent by an electronic label, such as a radio frequency identification (RFID) tag, a near field communication (NFC) tag, and the like, on the inner cooking pan, the notification message comprising the material type of the inner cooking pan.

In the present embodiment, an electronic label (for example, RFID label shown in FIG. 8) is added to an external surface of the inner cooking pan (or any other positions such as a surface of a packing box of the inner cooking pan) during the process of producing an inner cooking pan by a manufacturer. The electronic label contains the information on the material type of the inner cooking pan. As such, the material type of the inner cooking pan can be determined by activating the electronic label and receiving a notification message sent by the electronic label.

For example, an induction cooking equipment may be “an electric cooker”, and an electronic label may be “RFID label”. As shown in FIG. 8, a RFID label may be disposed on a surface of the inner cooking pan, the RFID label comprising the material type of the inner cooking pan, and the electric cooker may be configured with a RFID reader. When the inner cooking pan is placed adjacent to the electric cooker, making the RFID label enter the reading range of the RFID reader in the electric cooker can activate the RFID label, so as to receive a notification message sent by the RFID label, the notification message comprising the material type of the inner cooking pan.

Therefore, users neither need to take into account a material type of an inner cooking pan nor a fitting process between an electric cooker and an inner cooking pan, users only need to put the inner cooking pan into an electric cooker, then the electric cooker can read the information about a material type from the RFID label automatically by the RFID reader, and then select a corresponding voltage change curve.

### Embodiment 3

### Physical Structure

As another exemplary embodiment, a surface of an inner cooking pan can be configured to have a physical structure corresponding to its own material type, then a physical structure of a surface of the inner cooking pan can be detected by a detection structure in an equipment body of the induction cooking equipment after the inner cooking pan is installed into the equipment body, so as to determine the material type of the inner cooking pan.

Wherein, “physical structure” of an inner cooking pan may have various forms. Different material types of inner cooking pans need to correspond to different forms of physical structure, so as to distinguish among different material types of inner cooking pans clearly.

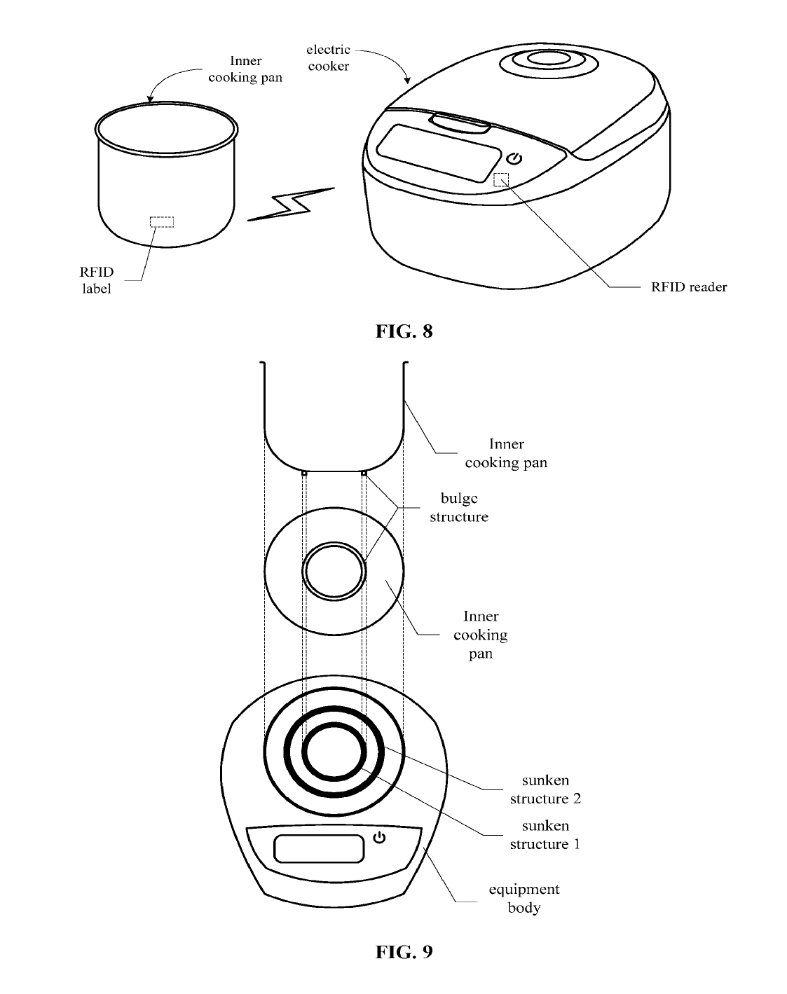

For example, assuming that the physical structure is a bulge structure on the bottom of the inner cooking pan. As shown in FIG. 9, the bulge structure may be an annular bulge on the bottom of the inner cooking pan, a material type of an inner cooking pan corresponding to the location of the annular bulge on the bottom of the inner cooking pan. For example, the radiuses of the annular bulge corresponding to different material types of tank are different. Accordingly, the detection structure may be a plurality of sunken structures on the bottom of the inside of the equipment body, and the plurality of sunken structures matching with bulge structures corresponding to a plurality of material types respectively. For example, the bottom of the inside of an equipment body shown in FIG. 9 may be configured with a first sunken structure having a smaller radius and a second sunken structure having a larger radius respectively.

As such, after the inner cooking pan is installed into the equipment body of the electric cooker, a bulge structure on the bottom of the inner cooking pan can only match with one of the sunken structures on the bottom of the inside of the equipment body. Since the material type corresponding to each sunken structure is known, the material type of the inner cooking pan can be determined by determining the sunken structure matching with the bulge structure. As shown in FIG. 9, the bulge structure on the bottom of the inner cooking pan corresponds to the first sunken structure in the equipment body, then it can be determined that the inner cooking pan is made of “material one”. Then a voltage change curve corresponding to material one in FIG. 4 should be used when the electric cooker selects the inner cooking pan to perform a cooking operation of “cooking rice” on the “rice”.

In the present embodiment, by using annular bulge structure and sunken structure, users don't need to take into account the problems of installing direction and posture and the like and only need to make the bottom of the inner cooking pan face down when putting the inner cooking pan into the equipment body, so as to aim at the sunken structure 1 directly without rotating to adjust in a horizontal direction, which may be useful for simplifying the user operation.

Moreover, in the technical solutions of the present disclosure, a voltage change curve in an induction cooking equipment may be from a variety of sources. For example, a voltage change curve may be pre-stored in an induction cooking equipment by a manufacturer. Or, users can create a new voltage change curve according to the actual demand and import it into an induction cooking equipment. Users can also edit and adjust existing voltage change curve in an induction cooking equipment. Wherein, users can import new voltage change curve into an induction cooking equipment by creating or editing a voltage change curve on a mobile device after connecting to the induction cooking equipment by the mobile device such as a smart phone. Or, an induction cooking equipment can be connected to Internet, so that the induction cooking equipment can download a voltage change curve from a server. The voltage change curve may be from a manufacturer, and may also be from other users, such as social friends of current user and the like. In fact, any methods capable of importing a voltage change curve into an induction cooking equipment may be used in the embodiments of the present disclosure, and the present disclosure is not limited to the above methods.

The present disclosure further provides embodiments of a device for displaying information corresponding to the foregoing embodiments of a method for displaying information.

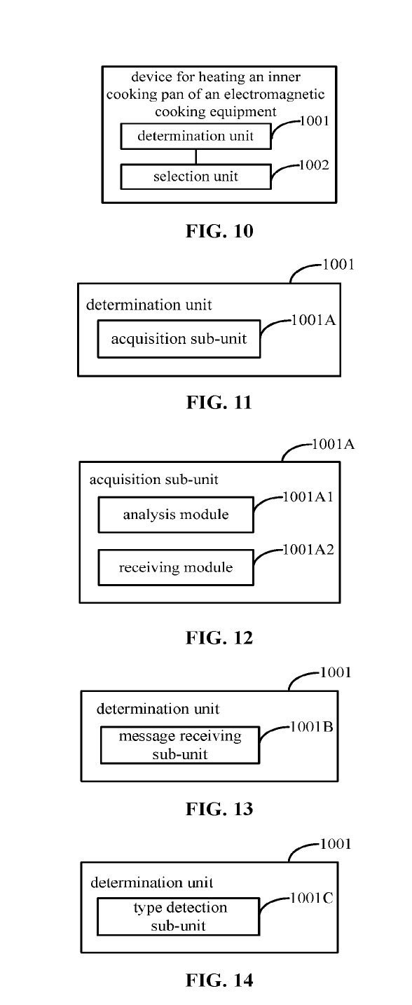

FIG. 10 is a block diagram illustrating a device for heating an inner cooking pan of an induction cooking equipment according to an exemplary embodiment. Referring to FIG. 10, the device may include a determination unit 1001 and a selection unit 1002. Wherein, the determination unit 1001 is configured to determine a material type of an inner cooking pan; and the selection unit 1002 is configured to select a voltage change curve matching with the material type for use in a cooking process of the induction cooking equipment which the inner cooking pan belongs to.

Alternatively, the voltage change curve is generated according to received configuration instructions or is downloaded from a server.

As shown in FIG. 11, FIG. 11 is a block diagram illustrating another device for heating an inner cooking pan of an induction cooking equipment according to an exemplary embodiment. Based on the foregoing embodiments shown in FIG. 10, the determination unit 1001 may include an acquisition sub-unit 1001A. Wherein, the acquisition sub-unit 1001A is configured to acquire the material type contained in a barcode graph on a surface of the inner cooking pan

As shown in FIG. 12, FIG. 12 is a block diagram illustrating another device for heating an inner cooking pan of an induction cooking equipment according to an exemplary embodiment. Based on the foregoing embodiments shown in FIG. 11, the acquisition sub-unit 1001A may include an analysis module 1001A1 or a receiving module 1001A2. Wherein, the analysis module 1001A1 is configured to acquire and analyze the barcode graph to acquire the material type contained in the barcode graph; and the receiving module 1001A2 is configured to receive an assisting message sent by a mobile device, the assisting message comprising the material type of the inner cooking pan; wherein, the material type is acquired by acquiring and analyzing the barcode graph by the mobile device.

As shown in FIG. 13, FIG. 13 is a block diagram illustrating another device for heating an inner cooking pan of an induction cooking equipment according to an exemplary embodiment. Based on the foregoing embodiments shown in FIG. 10, the determination unit 1001 may include a message receiving sub-unit 1001B. Wherein, the message receiving sub-unit 1001B is configured to receive a notification message sent by an electronic label on the inner cooking pan, the notification message comprising the material type of the inner cooking pan.

It's to be noted that the message receiving sub-unit 1001B in embodiments of a device shown in FIG. 13 may be included in embodiments of a device shown in FIGS. 11-12, the present disclosure is not limited in the context.

As shown in FIG. 14, FIG. 14 is a block diagram illustrating another device for heating an inner cooking pan of an induction cooking equipment according to an exemplary embodiment. Based on the foregoing embodiments shown in FIG. 10, when the surface of the inner cooking pan comprises a physical structure corresponding its own material type, the determination unit 1001 may include a type detection sub-unit 1001C. Wherein, the type detection sub-unit 1001C is configured to detect a physical structure of a surface of the inner cooking pan by a detection structure in an equipment body of the induction cooking equipment after the inner cooking pan is installed into the equipment body so as to determine the material type of the inner cooking pan.

It's to be noted that the type detection sub-unit 1001C in embodiments of a device shown in FIG. 14 may be included in embodiments of a device shown in FIGS. 11-13, the present disclosure is not limited in the context.

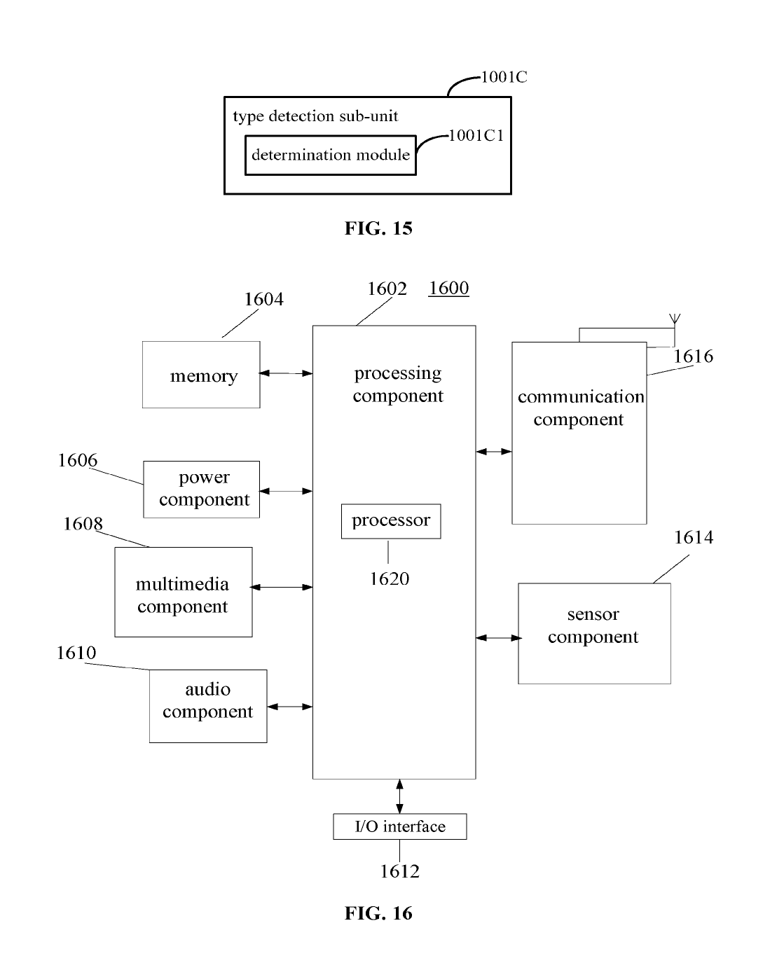

As shown in FIG. 15, FIG. 15 is a block diagram illustrating another device for heating an inner cooking pan of an induction cooking equipment according to an exemplary embodiment. Based on the foregoing embodiments shown in FIG. 10, the physical structure is a bulge structure on the bottom of the inner cooking pan, the material type corresponding to the location of the bulge structure on the bottom of the inner cooking pan; the detection structure is a plurality of sunken structures on the bottom of the inside of the equipment body, and the plurality of sunken structures matching with bulge structures corresponding to a plurality of material types respectively; the type detection sub-unit 1001C may include a determination module 1001C1. Wherein, the determination module 1001C1 is configured to determine a corresponding material type according to a sunken structure in the detection structure matching with a bulge structure on the bottom of the inner cooking pan after the inner cooking pan is installed into the equipment body of the induction cooking equipment.

With respect to the devices in above embodiments, specific manners in which respective modules perform operations have been described in detail in embodiments related to methods, which will not be elaborated herein.

For embodiments of the device, since they correspond to embodiments of the method, reference can be made to the description in embodiments of the method. The embodiments of the device described above are only illustrative. The unit described as a separate component may be or may not be separate physically. The component shown as a unit may be or may not be a physical unit, namely, the component may be located in a place or may be distributed over a plurality of network units. Part or all of the modules can be selected according to actual demand, so as to achieve the goal of the solutions of the present disclosure. An ordinary skilled person in the art can appreciate and practice the embodiments without creative work.

Accordingly, a device for heating an inner cooking pan of an induction cooking equipment is further provided in the present disclosure, comprising: a processor; a memory for storing processor-executable instructions; wherein the processor is configured to: determine a material type of an inner cooking pan; and select a voltage change curve matching with the material type for use in a cooking process of an induction cooking equipment which the inner cooking pan belongs to.

Accordingly, a terminal is further provided in the present disclosure, comprising: a memory; and one or more programs, wherein one or more programs are stored in the memory and are configured to be executed by one or more processors, one or more programs comprising instructions for performing the following operations: determining a material type of an inner cooking pan; and selecting a voltage change curve matching with the material type for use in a cooking process of an induction cooking equipment which the inner cooking pan belongs to.

It is noted that the various modules, units and components in the present disclosure can be implemented using any suitable technology. In an example, a module can be implemented using integrated circuit (IC). In another example, a module can be implemented as a processing circuit executing software instructions.

FIG. 16 is a block diagram of an device 1600 for heating an inner cooking pan of an induction cooking equipment according to an exemplary embodiment. For example, the device 1600 may be a mobile phone, a computer, a digital broadcast terminal, a messaging device, a gaming console, a tablet, a medical device, an exercise equipment, a personal digital assistant, and the like.

Referring to FIG. 16, the device 1600 may include one or more of the following components: a processing component 1602, a memory 1604, a power component 1606, a multimedia component 1608, an audio component 1610, an input/output (I/O) interface 1612, a sensor component 1614, and a communication component 1616.

The processing component 1602 typically controls overall operations of the device 1600, such as the operations associated with display, telephone calls, data communications, camera operations, and recording operations. The processing component 1602 may include one or more processors 1620 to execute instructions to perform all or part of the steps in the above described methods. Moreover, the processing component 1602 may include one or more modules which facilitate the interaction between the processing component 1602 and other components. For instance, the processing component 1602 may include a multimedia module to facilitate the interaction between the multimedia component 1608 and the processing component 1602.

The memory 1604 is configured to store various types of data to support the operation of the device 1600. Examples of such data include instructions for any applications or methods operated on the device 1600, contact data, phonebook data, messages, pictures, video, etc. The memory 1604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1606 provides power to various components of the device 1600. The power component 1606 may include a power management system, one or more power sources, and any other components associated with the generation, management, and distribution of power for the device 1600.

The multimedia component 1608 includes a screen providing an output interface between the device 1600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1608 includes a front camera and/or a rear camera. The front camera and the rear camera may receive an external multimedia datum while the device 1600 is in an operation mode, such as a photographing mode or a video mode. Each of the front camera and the rear camera may be a fixed optical lens system or have optical focusing and zooming capability.

The audio component 1610 is configured to output and/or input audio signals. For example, the audio component 1610 includes a microphone (“M1C”) configured to receive an external audio signal when the device 1600 is in an operation mode, such as a call mode, a recording mode, and a voice recognition mode. The received audio signal may be further stored in the memory 1604 or transmitted via the communication component 1616. In some embodiments, the audio component 1610 further includes a speaker to output audio signals.

The I/O interface 1612 provides an interface between the processing component 1602 and peripheral interface modules, the peripheral interface modules being, for example, a keyboard, a click wheel, buttons, and the like. The buttons may include, but are not limited to, a home button, a volume button, a starting button, and a locking button.

The sensor component 1614 includes one or more sensors to provide status assessments of various aspects of the device 1600. For instance, the sensor component 1614 may detect an open/closed status of thedevice 1600, relative positioning of components (e.g., the display and the keypad, of the device 1600), a change in position of the device 1600 or a component of the device 1600, a presence or absence of user contact with the device 1600, an orientation or an acceleration/deceleration of the device 1600, and a change in temperature of the device 1600. The sensor component 1614 may include a proximity sensor configured to detect the presence of a nearby object without any physical contact. The sensor component 1614 may also include a light sensor, such as a CMOS or CCD image sensor, for use in imaging applications. In some embodiments, the sensor component 1614 may also include an accelerometer sensor, a gyroscope sensor, a magnetic sensor, a pressure sensor, or a temperature sensor.

The communication component 1616 is configured to facilitate communication, wired or wirelessly, between the device 1600 and other devices. The device 1600 can access a wireless network based on a communication standard, such as WiFi, 2G, or 3G, or a combination thereof. In an exemplary embodiment, the communication component 1616 receives a broadcast signal or broadcast associated information from an external broadcast management system via a broadcast channel. In an exemplary embodiment, the communication component 1616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1604, executable by the processor 1620 in the device 1600, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for heating an inner cooking pan of an induction cooking equipment, comprising:
determining a material type of the inner cooking pan; and
selecting a voltage change curve based on the material type for use in a cooking process of the induction cooking equipment where the inner cooking pan is installed.

2. The method of claim 1, wherein determining the material type of the inner cooking pan comprises:
acquiring the material type that is encoded in a barcode graph on a surface of the inner cooking pan.

3. The method of claim 2, wherein acquiring the material type that is encoded in the barcode graph on the surface of the inner cooking pan comprises:
acquiring and decoding the barcode graph to acquire the material type encoded in the barcode graph; or
receiving an assisting message with the material type sent by a mobile device, wherein the mobile device is configured to read the barcode graph and decode the barcode graph to acquire the material type.

4. The method of claim 1, wherein determining the material type of the inner cooking pan comprises:
receiving a notification message sent by an electronic label on the inner cooking pan, the notification message comprising the material type of the inner cooking pan.

5. The method of claim 1, wherein when a surface of the inner cooking pan comprises a physical structure corresponding to the material type, said determining the material type of the inner cooking pan comprises:
detecting the physical structure of the surface of the inner cooking pan using a detection structure of the induction cooking equipment after the inner cooking pan is installed into the induction cooking equipment so as to determine the material type of the inner cooking pan.

6. The method of claim 5, wherein the physical structure is a convex structure on a bottom of the inner cooking pan, a location of the convex structure on the bottom of the inner cooking pan is indicative of the material type; the detection structure includes a plurality of concave structures on an inside bottom of the induction cooking equipment, and the plurality of concave structures correspond to a plurality of material types respectively; said detecting the physical structure of the surface of the inner cooking pan using the detection structure in the induction cooking equipment comprises:
determining a corresponding material type according to a concave structure in the detection structure that matches with the convex structure on the bottom of the inner cooking pan after the inner cooking pan is installed into the induction cooking equipment.

7. The method of claim 1, further comprising:
receiving configuration instructions; and
generating the voltage change curve according to the configuration instructions and the material type.

8. The method of claim 1, further comprising:
downloading the voltage change curve from a server.

9. A device for heating an inner cooking pan of an induction cooking equipment, comprising:
a processor; and
a memory for storing processor-executable instructions;
wherein the processor is configured to:
determine a material type of the inner cooking pan; and
select a voltage change curve based on the material type for use in a cooking process of the induction cooking equipment where the inner cooking pan is installed.

10. The device of claim 9, wherein the processor is further configured to:
acquire the material type that is encoded in a barcode graph on a surface of the inner cooking pan.

11. The device of claim 10, wherein the processor is further configured to:
acquire and decode the barcode graph to acquire the material type encoded in the barcode graph; and
receive an assisting message sent by a mobile device, wherein the mobile device is configured to read the barcode graph and decode the barcode graph to acquire the material type.

12. The device of claim 9, wherein the processor is further configured to:
receive a notification message sent by an electronic label on the inner cooking pan, the notification message comprising the material type of the inner cooking pan.

13. The device of claim 9, wherein when a surface of the inner cooking pan comprises a physical structure corresponding to the material type, the processor is further configured to:
detect the physical structure of a surface of the inner cooking pan by a detection structure in the induction cooking equipment after the inner cooking pan is installed into the induction cooking equipment so as to determine the material type of the inner cooking pan.

14. The device of claim 13, wherein the physical structure is a convex structure on a bottom of the inner cooking pan, a location of the convex structure on the bottom of the inner cooking pan is indicative of the material type; the detection structure includes a plurality of concave structures on an inside bottom of the induction cooking equipment, and the plurality of concave structures correspond to a plurality of material types respectively; the processor is further configured to:
determine the material type according to a concave structure in the detection structure that matches the convex structure on the bottom of the inner cooking pan after the inner cooking pan is installed into the induction cooking equipment.

15. The device of claim 9, wherein the processor is configured to receive configuration instructions and generate the voltage change curve according to the received configuration instructions and the material type.

16. The device of claim 9, wherein the processor is configured to download the voltage change curve from a server based on the material type.

17. A non-transitory computer-readable storage medium having stored therein instructions that, when executed by a processor of a mobile terminal device, causes the mobile terminal device to perform a method for heating an inner cooking pan of an induction cooking equipment, the method comprising:
determining a material type of an inner cooking pan; and
selecting a voltage change curve based on the material type for use in a cooking process of the induction cooking equipment where the inner cooking pan is installed.
